(19) United States
(12) Patent Application Publication
(10) Pub. No.: US 2002/0163746 A1
(43) Pub. Date: Nov. 7, 2002

(54) Server accelerator switch

(76) Inventor: David Y. Chang, San Jose, CA (US)

Correspondence Address: Rosemarie F. Jones, Esq., Heller Ehrman White & McAuliffe, LLP, 275 Middlefield Road, Menlo Park, CA, 94025-3506, US

(21) Appl. No.: 09/849,507

(22) Filed: May 4, 2001

(51) Int. Cl. G11B 5/00

(52) U.S. Cl. 360/1

(57) ABSTRACT

A system with one or more server accelerator (SA) switches provides accelerated or faster response to a network user. The SA switches may send data directly to a user, i.e., an initiating computer, without further intervention or post-processing of retrieved data by an origin server, thereby reducing the load on an origin server. The requirements from an origin server are thereby reduced, thus, also enabling an origin server to handle more user requests.

### BACKGROUND OF THE INVENTION

1. Field of the Invention

This invention relates generally to computer network communications and, more particularly, to accelerating responses to user requests within a network.

2. Description of the Related Art

When a computer network user begins a communication session over the Internet, the user can request data files from an Internet-connected computer called an origin server using several protocols or software interfaces, such as the hypertext transfer protocol (HTTP), file transfer protocol (FTP), real-time transport protocol (RTP), and the like. An origin server is typically a Web server on which a given resource resides or is to be generated. These data files are typically written or defined in a type of programming code or mark-up language called hypertext mark-up language (HTML), and can be presented through a graphical user interface (GUI) program, such as “Netscape Communicator” from Netscape Communications Corporation or “Internet Explorer” from Microsoft Corporation. Such data files may also be audio and video files such as MPEG, WAV, and AVI files. The network nodes and collection of such data files are commonly referred to as the “World Wide Web” (“WWW”) or the Internet and the GUI program to view the files is called a Web browser (“browser”). A collection of related data files under a common Internet network domain name is commonly referred to as a Web site.

Because of the improvement in technology, as well as the rising demand for information and entertainment, small-size traditional files typically between 1 kilobyte (KB) and 50 KB transmitted over the Internet have been augmented with larger-size files, such as music and video files, which may be hundreds or even thousands of kilobytes in size. For example, data files containing a three-minute song may be from 3 MB to 5 MB in size. A 2-hour movie, compressed, for example, by MPEG4, may be from 500 MB to 700 MB, or even more.

FIG. 1 shows how a conventional system 100 processes a request for such data files. Typically, a network user via a computer 105 is connected to a server load balancing (SLB) switch 110 via a data network 130, such as the Internet, a local area network, a wide area network, and the like. The SLB switch 110 in turn is connected to one or more origin servers 120 via a data network 132. One or more origin servers 120 communicate with each other via a data network 134. The disk, computer readable medium, or data store 125 may be internally or externally connected 136 to the origin server 120, e.g., contained in another computer (such as a database server) or in a RAID (redundant array of inexpensive disks). Routers may be employed if the origin servers are not in the same network. Examples of SLB switches 110 that may be employed in this configuration are the “ALTEON ACE DIRECTOR” series from NORTEL NETWORKS, and the “BIG-IP CONTROLLER” series from F5 Networks, Inc.

A request, such as an HTTP or RTP request, is initiated by a user on a computer 105, typically via a Web browser by typing in the URL address or by selecting a hyperlink on a displayed Web page. That request, shown as the Arrow A 152, is then transmitted via a data network 130, for example, via the Internet, and eventually to the SLB switch 110. The SLB switch 110, utilizing its server load balancing logic, uses factors such as response time, load, and server usage to decide which origin server will satisfy the user request 152. The SLB switch 110 then forwards the request, shown as the Arrow B 154, to the designated origin server 120. In most cases, a request is fulfilled by obtaining information from one or more computer-readable media 125, typically hard disk drives.

The designated origin server 120 takes charge of requesting information, shown as the Arrow C 156, from one or more disks 125. The origin server 120, for example, parses the HTTP URL (uniform resource locator) address, which is part of the request received (Arrow B 154), locates the data files containing the requested information, and then translates and generates the received request into the appropriate disk commands that are understood by the computer-readable medium or disk 125 (Arrow C 156). If the disk 125 is connected via a SCSI (Small Computer System Interface) connection, such request is translated to SCSI disk commands. If the interface is Wide SCSI, Fast SCSI, Ultra SCSI, IDE (Intelligent Drive Electronics), EIDE (Enhanced IDE), or ESDI (Enhanced Small Device Interface), the request is accordingly translated by the origin server 120 to the appropriate and corresponding disk commands.

Depending on the request, the origin server 120 may request several data files or information from the disk 125. The disk 125 sends the requested files or information, e.g., video data files, HTTP data files, back to the origin server, shown by the Arrow D 158. The origin server 120 processes the information that is received, may request more disk information as necessary, and sends the processed information as a response back to the initiating computer 105. The origin server 120, for example, may packetize (transform) the data in Video or HTTP packet format and reply to the Video/HTTP request. Such response, as shown by the Arrow E 160, is sent to the SLB switch 110, then to the user or initiating computer 105, as shown by the Arrow F 162. Thus, the origin server handles post-processing of retrieved data that is to be sent to the user, e.g., packetizing the data and sending it to the user. (A packet is a piece of a message transmitted generally over a packet-switching network. It typically contains the destination address in addition to the data.)

Because the origin server 120 takes charge of fulfilling requests, some resources of the origin server are tied up until a request is fulfilled, thereby potentially becoming a bottleneck in the system. In some cases, for example, where a request from a user is a request for a large file, such as an MPEG file containing a 2-hour movie that potentially takes hours for the user to download, a portion of the resources of the origin server is unavailable to other users until that user's request is completely satisfied. Thus, this leads to slow response time or failure by an origin server to respond to additional incoming requests, because some of the resources of the origin servers are tied up responding to existing requests for large-size files. The number of requests that an origin server can handle may also be substantially reduced as the number of requests for large files are received.

One way of alleviating the resource burden on an origin server is to have more origin servers. But more origin servers would mean more network administration complexities as well as code modifications to existing dynamic scripts on an existing Web site. Furthermore, high-end origin servers can be relatively expensive. Thus, it would be desirable to offload work from an origin server, to enable faster response to user requests, enable high-speed traffic within a network, and to enable an origin server 120 to handle more requests simultaneously. Furthermore, it would be desirable to offload work in a manner such that another Web server need not necessarily be purchased.

From the discussion above, it is apparent that there is a need for a system that addresses the difficulties and problems discussed above. The present invention fulfills these needs.

### SUMMARY OF THE INVENTION

The present invention provides accelerated or faster response to requests from a network user. This is done by employing one or more server accelerator (SA) switches that may send data directly to a user, i.e., directly to an initiating computer, without further intervention or post-processing of retrieved data by an origin server, thereby reducing the load on an origin server. The requirements from an origin server are thereby reduced, thus, also enabling an origin server to handle more user requests.

In one aspect, the invention provides a method of accelerating response to a computer network request. In the first operation of the method, a request from a network user is received. Examples of such requests may include HTTP, RTP, FTP, and the like. Next, such request is sent to an origin server. The request is then translated to one or more corresponding server accelerator switch (SAS) requests, which comprise at least a server accelerator request type, a connection ID, and one or more disk command(s). These SAS requests are then sent to one or more computer-readable media or data stores. Next, a determination of whether the server accelerator request type is “normal” or “accelerated” is performed. Optionally, if the server accelerator request type is “accelerated,” the set of data retrieved from disk is directly sent to the network user. Alternatively, if the server accelerator request type is “normal,” the set of data retrieved is sent to an origin server for post-processing, e.g., for transforming the data into packets and sending the packets to the user.

In another aspect, the invention provides for a server accelerator (SA) switch apparatus. This SA switch apparatus is capable of the following features: receiving a request from a network user; sending a request to an origin server; receiving one or more server accelerator switch (SAS) requests, which typically comprise at least a server accelerator request type, connection ID, and disk command(s); sending the SAS requests to retrieve data from data store; and determining whether a server accelerator request type is “normal” or “accelerated.” Depending on the server accelerator request type, the SA switch apparatus may process the retrieved data and send the data directly back to the user or send the retrieved data to an origin server for post-processing.

In another aspect, the invention provides for an origin server that translates a network user request to one or more corresponding server accelerator switch (SAS) requests, wherein each of said SAS requests comprises at least a server accelerator request type, connection ID, and disk command(s).

In another aspect, the invention provides for a server accelerator system that enables faster response to network requests. The system comprises at least three components: (1) a server accelerator (SA) switch that interfaces to one or more origin servers and to one or more data stores, and wherein said SA switch may send data to a network user directly when an “accelerated” server accelerator request type is received; (2) an origin server that translates a user's request to one or more server accelerator switch (SAS) requests and wherein each of said SAS requests comprises at least a server accelerator request type, connection ID, and disk command(s); and (3) a data store wherein data files may be written to and read from.

Other features and advantages of the present invention should be apparent from the following description of the preferred embodiment, which illustrates, by way of example, the principles of the invention.

### BRIEF DESCRIPTION OF THE DRAWINGS

FIG. 1 is a block diagram representation of a conventional data network arrangement, particularly an Internet arrangement, which enables an origin server to satisfy a user request.

FIG. 2 is a block diagram representation of a server accelerator system constructed in accordance with the present invention.

FIG. 3 is a block diagram representation of a server accelerator switch constructed in accordance with the present invention.

FIG. 4 illustrates the operation of the server accelerator system of the present invention.

### DETAILED DESCRIPTION

The following detailed description illustrates the invention by way of example, not by way of limitation of the principles of the invention. This description will clearly enable one skilled in the art to make and use the invention, and describes several embodiments, adaptations, variations, alternatives and uses of the invention, including what we presently believe is the best mode of carrying out the invention.

The invention will be described by way of illustration with reference to HTTP or RTP requests, but it should be understood that any type of requests over 1the Internet or over a data network that requires reading of information from one or more computer readable media, particularly hard disk drives, may also employ the features of the present invention.

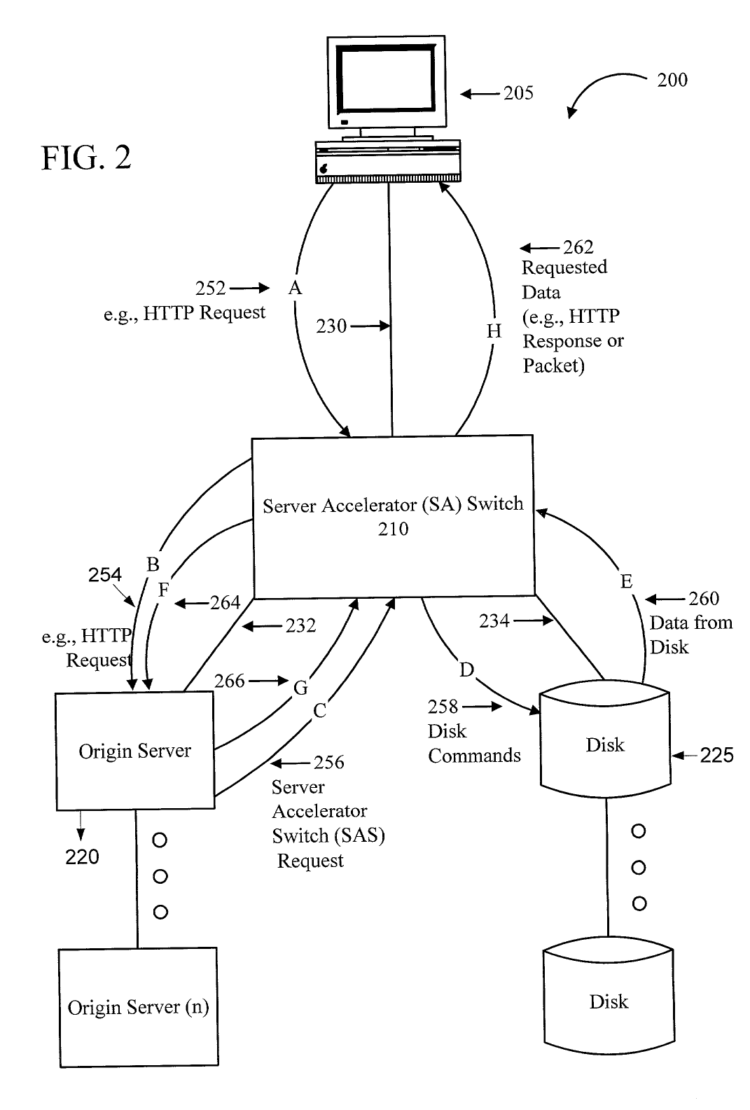

FIG. 2 is a representation of a server accelerator system 200 that satisfies requests such as HTTP, RTP, FTP, and NFS (network file system) requests, from a network user in accordance with the present invention. A network user of a computer 205 at a network node is connected to a server accelerator (SA) switch 210 via a data network 230. The SA switch 210 is connected to an origin server 220 via a connection 232, such as a data network, that enables the SA switch and the origin server to communicate with each other. The SA switch 210 is also connected to a disk, computer-readable medium, or data store 225 via a connection 234, which enables the SA switch 210 and the disk 225 to communicate with each other. The SA switch 210 may be connected to one or more origin servers 220 as well as to one or more disks or data stores 225. Arrows A, B, C, D, E, F, G, and H illustrate the general order of how a user request is processed within the server accelerator system 200.

A network user at a computer or any Internet-enabled appliance 205, typically using a browser program or any software enabling requests to Web servers, such as an FTP software, communicates with the origin server 220 via the data network 230, such as the Internet, through a series of network connections. Such user request, e.g., an HTTP request, shown as the Arrow A 252, is received by the SA switch 210. In one embodiment, the SA switch 210 also contains a server load balancing (SLB) component, which may be a software, firmware, or hardware module that determines which of the origin server connected to the SA switch 210 is appropriate to satisfy the received user request. Factors such as response time, load, memory usage, network usage, overall system load, and the like may be considered.

The SA switch 210, for example, using server load balancing logic, determines to which origin server it will send the request. The SA Switch 210 then sends the received request (e.g., an HTTP request, shown as the Arrow A 252), to the designated origin server, as shown by the Arrow B 254. For the origin server to respond to a user's request, however, the origin server has to be able to understand and interpret that user's request 252. This is usually handled by the Web server software running in the origin server. For example, to be able to respond to an HTTP request, the origin server 220 should be running a Web server software that understands HTTP. An HTTP request is typically in a form of a URL (uniform resource locator) address, e.g.,

“http://www.XyzCo.com/index.htrnl,”

“http://www.XyzCo.com/ page2.html?id=5234,”

and the like. If the request is an FTP request, the origin server 220 should be running a Web software application that understands FTP.

Depending on the request received, the origin server 220 then translates the received request 254 into one or more server accelerator switch (SAS) requests and then sends such SAS requests, as shown by the Arrow C 256, back to the SA switch 210. Typically, an application programming interface (API) is installed as part of the Web server software running in the origin server 220 to enable the Web software to do this translation. This may also be implemented via DLLs (dynamic link libraries) that are called by the Web server software. Generally, the origin server 220, in this embodiment, parses incoming requests or packets, determines the file system access to the appropriate data files, and generates the proper SAS requests.

If the request received 254 is an HTTP request, for example, then the origin server 220, in conjunction with the Web server software with the appropriate API, first parses the HTTP request, determines the physical location of the file(s) containing the information requested, and then generates one or more SAS requests to access the proper file(s) on disks. An SAS request, further discussed below, typically contains an SAS request type, connection ID information, and the appropriate disk interface commands (or disk commands). A disk interface command, such as a SCSI disk command, instructs the appropriate hardware to read certain files from disk to be returned to the SA Switch 210.

Once the SA Switch 210 receives the SAS request, as shown by the Arrow C 256, it sends the disk interface commands to the disk 225, as shown by the Arrow D 258. The requested information or data files retrieved from disk, shown in the Arrow E 260, are then sent back to the SA switch 210. If no further processing is required from the origin server 220, identified by an SAS request type, “accelerated,” the SA switch 210 packages or packetizes the requested information into an appropriate response, such as an HTTP response or packets, and sends the response to the initiating computer 205, as shown by the Arrow H 262. A completion status, indicating that the request has been satisfied, may also be sent back to the origin server by the SA switch 210.

In this embodiment, information retrieved from disk(s) that needs no further processing by the origin server (e.g., does not need to be contained in a dynamically-generated Web page) is sent directly to the initiating computer (user) without further intervention from or control by the origin server, or tying up the resources of the origin server while a user completely downloads the requested information or files. This alleviates the load on the origin server and boosts data transfer performance of the system 200 in general (because some of the post-processing steps typically done in a conventional system by an origin server are thus now handled by the SA switch). Web sites that serve large files may employ a series of SA Switches 210 to handle disk-intensive requests rather than employing more origin servers. (The cost of an SA Switch 210 is comparatively cheaper than an origin server.)

If further processing, however, is required from the origin server, identified by an SAS request type, “normal,” the information or files retrieved from the disk 225 are sent by the SA switch 210 to the origin server 220 for further processing (Arrow F 264). If a user request requires several information from the disk 225, several SAS requests may be generated and data flows shown by the Arrows B, C, D, E, F, and/or G may be repeated until the required information or data files to satisfy and complete the user's request are read from disk and processed. Once the information or data files requested are available to the origin server, it 220 packetizes the data into the appropriate packet format, e.g., HTTP packet format, and sends the response back via the SA switch (shown as the Arrow G 266) to the initiating computer, as shown by the Arrow H 262.

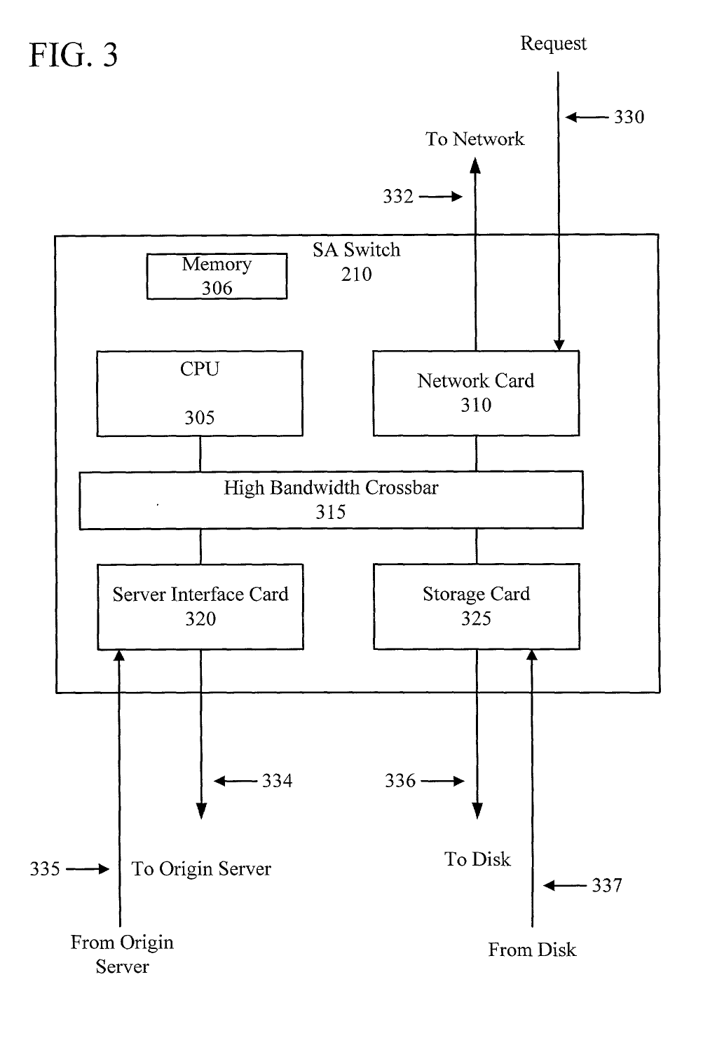

FIG. 3 is a block diagram representation of an embodiment of an SA Switch 210 in accordance with the present invention. The SA switch 210 typically comprises a central processing unit (CPU) 305, memory 306, a network card 310, a high bandwidth crossbar 315, a server interface card 320, and a storage card 325. One skilled in the art will realize that depending on the requirements on the SA switch 110, the number of each component may be more than one, e.g., there may be more than one CPU or server interface card.

The CPU 305 is the component that typically executes programming instructions stored in the memory 306. Depending on the sophistication of the functions provided by the SA switch 210, the SA switch may interface with various software, hardware, or firmware components, e.g., a server load balancing component, internal to or external from the SA switch. The CPU processes the instructions received or read from the various components and other instructions needed to implement the features of the present invention.

In conjunction with the other components that the SA switch interfaces with, the SA switch, using its CPU, may act as a server load balancing dispatcher, a server accelerator switch (SAS) input/output request dispatcher, an SAS manager, and the like. A server load balancing dispatcher decides which origin server should handle the user request. An SAS I/O request dispatcher sends one or more SAS requests to a specific storage card 325 to handle such SAS requests. An SAS manager administers and manages the SA switch 210, such as by monitoring statistics and traffic, configuring the addition of more SA switches and/or origin servers, and the like.

The network card 310 is an interface that connects the SA switch 210 to the network 230 (in FIG. 2), as shown by the arrow 332. It is also the interface, which receives user requests from the network 230 as shown by the arrow 330. Thus, the network card comprises a node of the computer network.

The server interface card 320 is an interface that connects the SA switch 210 to the origin servers 220, via a data network 232 (FIG. 2), as shown by the arrows 334 and 335, and enables the communication between the SA switch 210 and the origin servers 220.

The storage card 325 is the interface that connects the SA switch to the disks or data stores 225 (FIG. 2), as shown by the arrows 336 and 337. The storage card 325 handles the data access (disk read/write) from one or more disks 225 (using the disk commands generated by the origin server), may handle the scheduling of data transmission, including rate of transmission (e.g., schedule transmission to origin server or to initiating computer), may handle transforming data into packets, such as transforming data into the appropriate packet format (e.g., IP format versus IPX format), and the like.

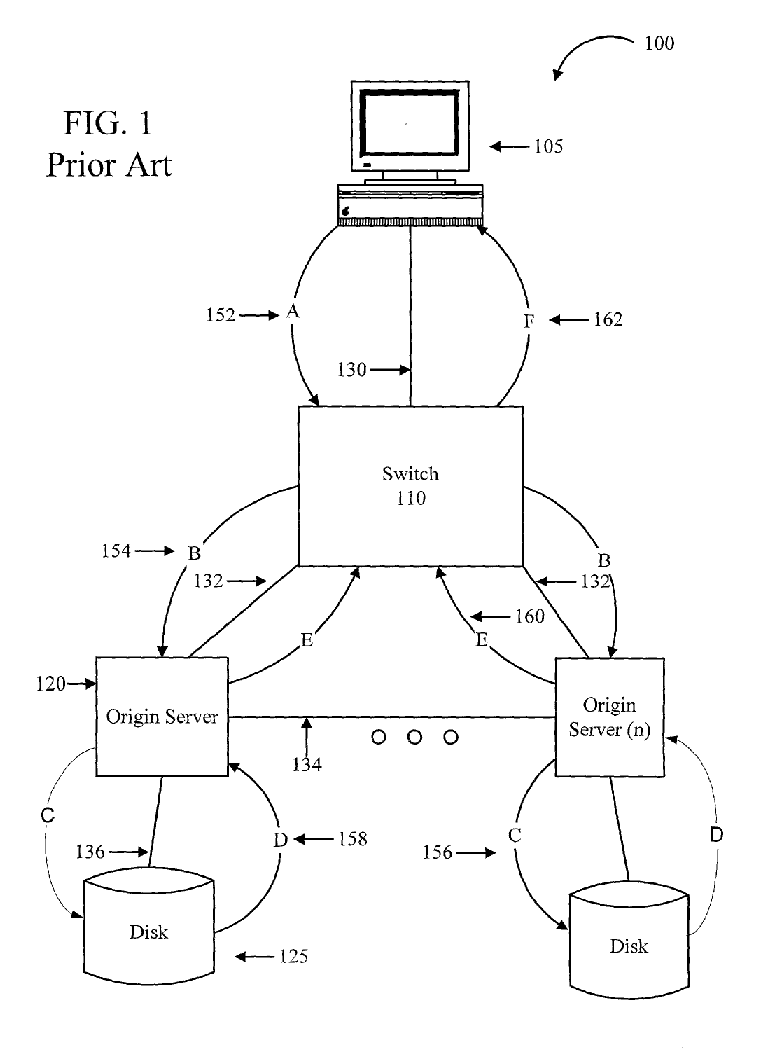

The high bandwidth crossbar 315 enables the various components of the SA switch 210, such as the CPU 305, network card 310, and the like, to communicate with each other. The crossbar 315 is preferred to have a high capacity to boost performance, thereby enabling data to be exchanged in a very high speed and enabling a higher throughput as compared to using an origin server as shown in the conventional system 100 illustrated in FIG. 1.

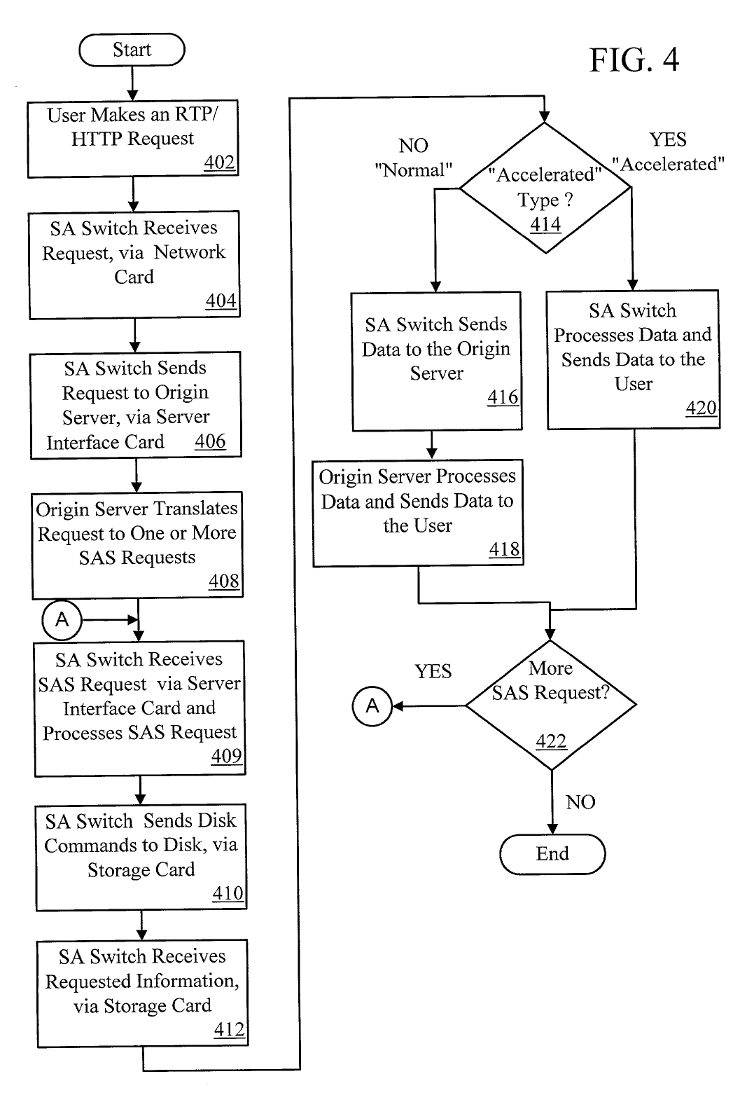

To facilitate understanding, figure numbers in the 200 series, 300 series, and 400 series, are typically found in FIG. 2, FIG. 3, and FIG. 4, respectively.

FIG. 4 illustrates the operations of the server accelerator system 200 of the present invention, particularly it shows how the server accelerator system processes an RTP or HTTP request. RTP is an Internet protocol for transmitting real-time data such as audio and video. In the first operation 402, the user makes a request via a computer 205 (Arrow A 252). In the next operation 404, the SA switch 210, particularly the network card 310, receives such request (Arrow A 252 and 330). The CPU 305 then processes the request. If server load balancing (SLB) is available, the CPU 305, using SLB logic, considers factors such as response time, load, network usage, and the like to determine which origin server will serve or satisfy such user request. The SA switch sends or forwards the request to the designated origin server as shown by the next operation 406. In particular, the CPU sends the request via the high bandwidth crossbar 315 and then via the server interface card 320, which then sends such request to the origin server (the Arrow B 254 and Arrow 334).

In the next operation 408, the origin server 220, in conjunction with the appropriate Web server software and API, translates the user request received to one or more corresponding SAS requests. The origin server 200 typically parses the request, determine the physical location of the file(s) on disks (e.g., track and volume of the file) containing the requested information, and generates one or more corresponding SAS requests. An SAS request typically includes an SAS request type, connection ID, and the appropriate disk commands. To illustrate, if the origin server receives the request

“http://www. XyzCo.com/xjpg”,

the origin server parses such HTTP request and determines the physical location of the xjpg file, for example, in this case, it is located in a disk 1 or file directory “x:\companyXYZ\images\x.jpg.” The origin server then translates the request received into one or more corresponding disk I/O commands to retrieve the xjpg file.

In one embodiment of the invention, there are two types of SAS request: “accelerated” and “normal.” The “accelerated” requests are typically requests for files, which require no further processing by the origin server. For example, a request for a beta software to be downloaded and saved into the user's computer 205 entails no further processing required from the origin server because a further Web page need not be displayed to the user. On the other hand, requests with “normal” type are typically those requests, which need to be processed by the origin server. (A request requiring that information or data files retrieved from one or more disks be incorporated into a dynamically generated Web page, such as a search result Web page, is an SAS request that needs further processing from the origin server.)

A connection ID is a unique identifier for any connection on a data network. It contains several pieces of information, which may be obtained, for example, from the IP (Internet Protocol) and transport header information. The connection ID information typically contains the source IP address (e.g., user's IP address), the source port number (on transport layer), destination IP address (e.g., address of Web site), destination port number (on transport layer), and IP protocol ID. The IP protocol ID identifies the transport type such as transmission control protocol (TCP), user datagram protocol (UDP), and the like. Other network protocols, other than IP, e.g., IPX, are also supported in the present invention.

In the next operation 409, the SA switch 210 receives the SAS request(s) (Arrow C 256), including the disk commands, from the origin server via the server interface card 320 (arrow 335) and processes the SA request. The disk commands generated by the origin server as part of the SAS request depend on the disk interface. For example, if the disk interface is SCSI, the origin server accordingly generates SCSI disk commands incorporated as part of the SAS request; if the disk interface is IDE, IDE disk commands are appropriately generated.

The SAS requests received by the server interface card 320 are transmitted to the storage card 325 via the high bandwidth crossbar 315. The storage card 325 processes the SAS requests received and generates a unique tag associated for each SAS request. If the disk 225 is connected via a SCSI controller, for example, the storage card 325 generates a unique SCSI tag associated with each SAS request.

In the next operation 410, the SA switch sends the disk commands to disk, in particular via the storage card 325 (Arrow D and 336). Next 412, data retrieved or read from disk are then received by the SA switch, in particular by the storage card 325 (Arrow E and 337).

The CPU 305 then checks the SAS request type, i.e., whether the request type is “accelerated” or “normal.” If the request type is “normal,” as shown by the “no” outcome at decision box 414, the SA switch 210, particularly the storage card 325 (via the high bandwidth crossbar switch 315 and the server interface card), sends the data retrieved from disk to the origin server at the next operation 416 (Arrow F 264 and 334). In the next operation 418, the origin server 220 processes the data received and sends such data back to the user (i.e., the initiating computer 205). In particular, the origin server 220 transforms the data received into the proper format or packets (packetizes) (e.g., HTTP or RTP format) and reply to the HTTP or RTP request by sending the data back to the user via the network card 310 (Arrows G and H, 332). Further processing from the origin server may include dynamically generating an appropriate Web page incorporating the information retrieved from disk 225, making further calculations based on the received information, sending instructions to update a database server, and the like.

If the CPU 305 determines that the SAS request type is “accelerated,” a “lyes” outcome at decision box 414, the SA switch 210 processes the data received from disk and sends such data to the user (i.e., the initiating computer 205) at operation 420. In particular, the network card 310, using the unique tag, e.g., SCSI tag, associates the connection ID information with the data contained in the storage card 325. In addition, the network card 310 packetizes the data received into the proper packet format, replies to the HTTP or RTP request by sending the data to the initiating computer, and, optionally, returns an SAS request completion status back to the origin server (Arrow H and 332). An SAS request completion status is sent via the server interface card 320 (334) back to the origin server 220.

If another SAS request needs to be processed, a “yes” outcome at decision box 422, further operations has to be done as shown by the arrow labeled A.

As discussed above and considering that hardware solutions are typically faster than software solutions (e.g., handled by software residing on an origin server), a major potion of post-processing of data retrieved from disk can be accelerated by the SA switch 210. In addition, the load or burden on the origin server's central processing unit is offloaded thus enabling the origin server to assign the origin server's CPU to do other tasks. Moreover, a particular disk may be directly accessible from any origin server without going through another origin server.

One skilled in the art will recognize that variations in the steps, as well as the order of execution, may be done and still make the invention operate in accordance with the features of the invention.

The present invention has been described above in terms of a presently preferred embodiment so that an understanding of the present invention can be conveyed. There are, however, many configurations for server accelerator systems not specifically described herein but with which the present invention is applicable. The present invention should therefore not be seen as limited to the particular embodiments described herein, but rather, it should be understood that the present invention has wide applicability with respect to network server accelerator systems generally. All modifications, variations, or equivalent arrangements and implementations that are within the scope of the attached claims should therefore be considered within the scope of the invention.

I claim:

1. A method of accelerating response to a computer network request, the method comprising:
receiving a request from a network user;
sending said request to an origin server;
translating said request to one or more corresponding server accelerator switch (SAS) requests wherein each of said SAS requests comprises at least a server accelerator request type, connection ID, and disk command(s);
sending said SAS requests to one or more computer-readable media or data stores to retrieve data; and
determining whether said server accelerator request type is a “normal” or “accelerated” type and determining processing of the retrieved data.

2. A method as defined in claim 1, further comprising:
directly sending said data retrieved to said network user when said server accelerator request type is “accelerated.”

3. A method as defined in claim 2, further comprising:
sending an SAS request completion status.

4. A method as defined in claim 1, further comprising:
sending said retrieved data to an origin server for processing; and
sending said processed data to said network user when said server accelerator request type is “normal.”

5. A server accelerator (SA) switch apparatus wherein said SA switch apparatus comprises:
a CPU that executes programming instructions; and
memory containing programming instructions that, when executed by the CPU, cause operations wherein the SA switch receives a request from a network user, sends said request to an origin server, receives one or more server accelerator switch (SAS) requests, wherein each of said SAS request comprises at least a server accelerator request type, connection ID, and disk command(s), sends said SAS requests to retrieve data from data store, and determines whether said server accelerator request type is a “normal” or “accelerated” type and determines processing of the retrieved data.

6. An SA switch apparatus as defined in claim 5, wherein said SA switch apparatus further directly sends said retrieved data to said network user when said server accelerator request type is “accelerated.”

7. An SA switch apparatus as defined in claim 6, wherein said SA switch apparatus further sends an SAS request completion status.

8. An SA switch apparatus as defined in claim 5, wherein said SA apparatus further sends said data retrieved to an origin server to process and sends said processed data to said network user when said server accelerator request type is “normal.”

9. An origin server apparatus used for network processing, wherein said origin server apparatus translates a network user request to one or more corresponding server accelerator switch (SAS) requests, wherein each of said SAS requests comprises at least a server accelerator request type, connection ID, and disk command(s).

10. A server accelerator system that enables faster response to network requests, the system comprising:
a server accelerator (SA) switch that interfaces to one or more origin servers and to one or more data stores, and wherein said SA switch may send data to a network user directly when a server accelerator switch (SAS) request that is type “accelerated” is received;
an origin server that translates a user's request to one or more server accelerator switch (SAS) requests and wherein each of said SAS request comprises at least a server accelerator request type, connection ID, and disk command(s); and
a data store wherein data files may be written to and read from.
